(19) United States
(12) Patent Application Publication
(10) Pub. No.: US 2011/0005396 A1
(43) Pub. Date: Jan. 13, 2011

(54) Economic Air Filter For Household

(76) Inventor: Jing Lu, Doraville, GA (US)

Correspondence Address: Jing Lu, 2626 Addison Dr., Doraville, GA, 30340, US

(21) Appl. No.: 12/501,409

(22) Filed: Jul. 11, 2009

(51) Int. Cl. B01D 46/10

(52) U.S. Cl. 96/222; 55/501; 55/528; 55/500

(57) ABSTRACT

The Economic Air Filter for Household according to the present disclosure includes two Claims: (1) A re-usable metal net AIR FILTER CASE/FOLDER/SANDWICH for holding the AIR FILTER SHEET; (2) The TWO WAY AIR FILTER SHEET series, and AIR FILTERING FOLD SHEET.

The re-usable metal net Air Filter Case/Folder/Sandwich (Claim I) designs are a creation to reduce the air filters waste amount for Green Environment Campaign. The TWO WAY AIR FILTER SHEET series (Claim II) is another creative idea to form a complete set of the Economic Air Filter for Household. The AIR FILTERING FOLD SHEET is designed with dust pocket for household who have pets or newly painted rooms. The basic Two Way Air Filter Sheet is disposable as regular household garbage, and effectively filtering out the Debris & Lint and Household Dust to protect Heating and A/C system. With filter elements in inner layer in series that can target different problems. Such as, Pollen, Dust Mite Debris, Mold Spores, Pet Dander, Smoke, Smog, Bacteria, Particles that can carry viruses and odor.

If any Two Way Air Filter Sheet product in the series requires special dispose procedures, we will clearly Label it.

### BACKGROUND OF THE INVENTON

1. Field of the Invention

The present invention relates to Air Filter inside of the White Return Grill for the Heating and A/C system in Household and Office. The invention is efficient for cleaning air and offer fresh air at home and office. The unique of our invention can reduce the air filter waste amount, compare with other air filters currently on the market for Green Environment Campaign. And save 60%-80% of money for consumers that spend on Air Filter.

2. Description of the Related Art

Everybody knows the Air Filters used in their home and office. These filters are essential to filter out dust and other particles in the air that come out from the White Return Grill on side wall and/or ceiling. In the household who have Pats, may need more frequently changes of the air filters.

Those air filters currently on the market are metal wire mixed/pressed with filtering fibers together (or glass fibers) with cardboard frame. The metal wire mixed with fiber and glass fibers are not recyclable since it's a mixed waste, and the metal can't be dissolved by the nature. It might take a long time (about 20-30 years) to degrade the waste into dirt/soil.

Our invention of the re-usable metal net Air Filter Case can be used for many years and easy metal recycle. The fibers only Two Way Air Filter Sheet is small in waste after using, and easy digested by the nature in the garbage heap yard. Safe and GREEN for our environment! Also save money for consumers!

### SUMMARY OF THE INVENTION

Benefit claimed on Claim I: (1) Reduce the household air filters waste amount that current products generate; (2) Save and Green for our environment campaign! (3) Save 60%-80% money for consumers by using our new invention!

Benefit claimed on Claim II: (1) Filter out household dust, Pet's hair and Debris & Lint to protect Heating and A/C system; (2) Treatment for filtering out the Pollen, Dust Mite Debris, Mold Spores, Pet Dander, Smog, Bacteria and particles that can carry viruses; (3) Special order for Odor treatment; (4) Serve as an Air Freshener.

### DETAILED DESCRIPTION OF THE INVENTION

The product of Claim 1, wherein the first Model of Re-usable metal Air Filter Case is made out of hot zinc coating metal net (rust free) with 20×30 mm mesh open. The actual product should have larger mesh open. The side wrapping frame material is also thin hot zinc coating metal plate that selected for 100% Rust free, smooth surface is safe for people to handle and pretty looking. No wash is required.

The Re-usable metal Air Filter Case is designed for easy changes of the Two Way Air Filter Sheet, from the sides or on top.

The product of Claim 2, wherein the Two Way Air Filter Sheet, the series type is not specifically limited as long as there is a new design and new agent that can target certain particles that can carry different types of viruses.

The Two Way Air Filter Sheet is made of paper/cotton fiber. The inner layer may include natural fibers and/or manufactured. The natural fiber layers are most conveniently cotton, but other natural fibers such as silk, jute, ramie, flax, cellulosic fibers, wool and the like may be used. The manufacture fiber layers are most conveniently made of synthetic fibers, such as Spunbond polyester, but can also be made of other synthetic fabrics (nylon, olefin, acrylic, etc.) Any suitable fibers may be used, with absorbent, efficient to attach dust and particles that can carry viruses are desirable.

The product of Claim 2 inner layer, wherein the fibrous filter media may be treated with oil or other tacking agents that may extend the ability to filter out the Pollen, Mold Spores, Pet Dander, Bacteria, Particles that can carry viruses and particles that can carry odor, etc. , respectively in the series.

In operation, the particulate of the Two Way Air Filter Sheet (Claim II) is placed inside of the re-usable metal net Air Filter Case/Folder/Sandwich, which is the base part of the invention in Claim I.

In conclusion, the changeable and disposable paper fiber of the Two Way Air Filter Sheet is environmental GREEN product. Along with the re-usable metal Air filter Case/Folder/Sandwich together is a huge money saving invention for consumers on Air Filter. More importantly, the inner layer of the Air Filter Sheet can contain some new bio-technology that helps stop the particles that can carry specific type of viruses in the air. This Air Filter Sheet invention can be useful and helpful to stop virus during the situation that a virus infection is transferred through air.

### BRIEF DESCRIPTION OF THE DRAWINGS

A) FIG. 1-FIG. 6 for CLAIM I—CASE/FOLDER/SANDWICH

The re-usable Air Filter Case is designed to change the Air Filtering Sheet that has dust pocket easily from either side of the Air Filter Case. Also the top of the re-usable metal net Air Filter Case is framed and kept open on top for the option to change the Air Filtering Sheet by pulling wider on top.

The re-usable Air Filter Folder or/and Sandwich are designed for the Two Way Air Filtering Sheet.

FIG. 1 is a front elevation view thereof Claim I—CASE.

FIG. 2 is a side elevation view thereof Claim I—CASE.

FIG. 3 is a front elevation view thereof Claim I—FOLDER.

FIG. 4 is a side elevation view thereof Claim I—FOLDER.

FIG. 5 is a front elevation view thereof Claim I—SANDWICH.

FIG. 6 is a side elevation view thereof Claim I—SANDWICH.

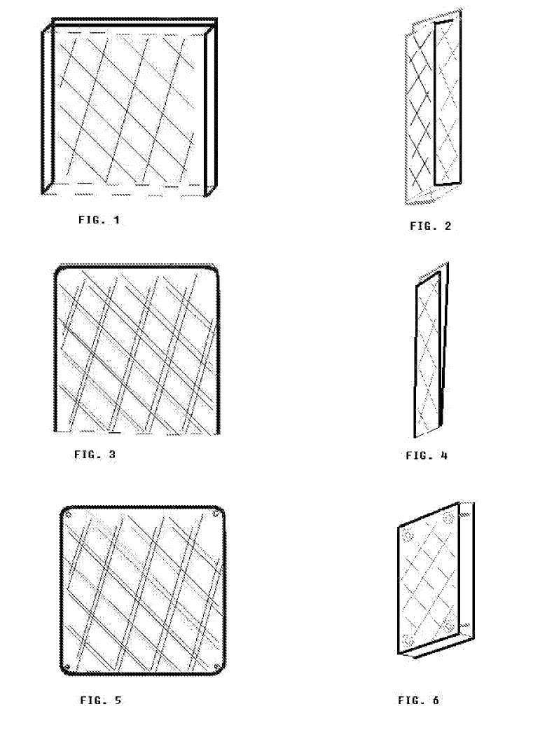

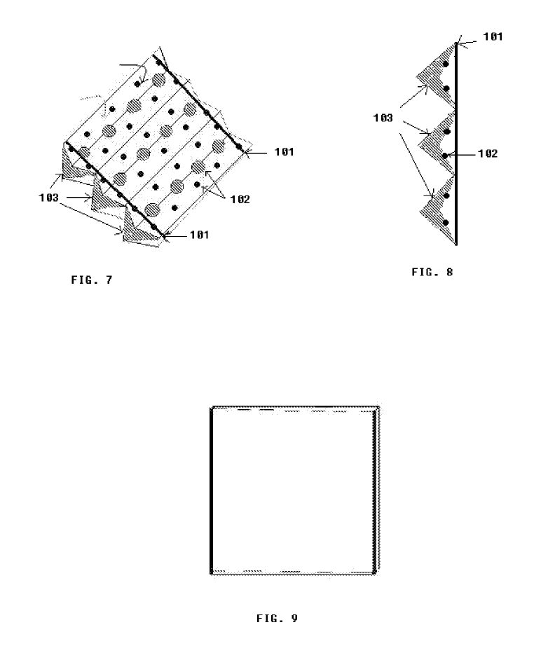

B) FIG. 7-FIG. 9 for CLAIM II—AIR FILTERING SHEETS

The Air Filtering Fold Sheet is designed for heavy dust area and/or newly painted household use which shown in FIGS. 7-8. The 101 are two Stable Strips to secure the whole Air Filter Fold Sheet. The 102 are holes for increasing the air flow efficiency. The 103 are dust pockets for holding more dust on the bottom, so the Air Filtering Fold Sheet can use longer time for household. The dust pocket is especially designed to filter out the flow wet painting dust from a newly painted house.

The Two Way Air Filter Sheet is designed that you can use either side of the filtering sheet toward the airstream that come out from the outlet duct of the Heating and A/C system on the side wall or ceiling. The Two Way Air Filter Sheet is pre-cut the same size (or 0.5 inch wider on each side) as the re-usable metal net Air Filter Folder/or Sandwich to cover the whole area.

FIG. 7 is a front elevation view thereof Claim II—Air Filtering Fold Sheet.

FIG. 8 is a side elevation view thereof Claim II—Air Filtering Fold Sheet.

FIG. 9 is a front elevation view thereof Claim II—Two Way Air Filtering Sheet.

What is claimed is:

1. The re-usable metal net Air Filter Case/Folder/Sandwich designs are created for holding the Air Filtering Sheet. The hot zinc coating metal plate material is selected for rust free, and tolerating heat and cold air that come out through the White Return Grill on the side wall or ceiling from Heating and A/C system. Our re-usable Air Filter Case/Folder/Sandwich designs patent application is covering all the Air Filter sizes (For example, 20×25×1; 20×20×1; 16×25×1; 14×25×1; 12×24×1,. . . etc.), all thickness and shapes of the mesh open, and all kind of materials. Such as, different types of metal and/or plastic. The reusable metal Air Filter Case/Folder/Sandwich is framed for good looking and holding by hand safety. The actual sizes of the Air Filter Case/Folder/Sandwich should be a little smaller (about 1/4 inches smaller) than the White Return Grill's relatively sizes in the household.
Our re-usable Air Filter Case/Folder/Sandwich designs can reduce the household air filters waste amount that current products generate. Those air filters currently on the market are metal wire mixed/pressed together with the filtering fibers. The mixed waste of metal wire, fibers and glass fiber can't be dissolved by the nature for a long time (about 20-30 years). Our re-usable metal net Air Filter Case/Folder/Sandwich can be used for many years with changeable Air Filtering Sheet, and easy metal recycle.

2. The TWO WAY AIR FILTER SHEET is pre-cut the same size for the different sizes of the re-usable metal Air Filter Case/Folder/Sandwich's sizes. The basic paper fiber surface can substantially filter out household dust, Pet's hair and Debris & Lint to protect Heating and A/C system.
In additional, our TWO WAY AIR FILTER SHEET patent application should also cover and useful for Floor Diffusers by putting the Two Way Air Filter Sheet inside the holder.
The AIR FILTERING FOLD SHEET is designed for heavy dust area use, and newly painted rooms. The dust pocket can hold more dust to avoid the frequent change of AIR FILTER SHEET in the heavy dusty situation. Also the two layers of folding pocket with holes on the top layer is designed to avoid the newly painted rooms' wet float in the air's painting dust to block the filtration sheet's small opening, and the painting dust will be stored inside the dust pocket instead of float back to the air.
The Two Way Air Filter Sheet series are:
a) A build-in inner layer that contain treatment for filtering out the Pollen, Dust Mite Debris, Mold Spores, Pet Dander, Smog, Bacteria and particles which can carry viruses.
b) The Two Way Air Filter Sheet can be scented or non-scented.
c) The Two Way Air Filter Sheet can serve as an Air Freshener. With our special “Fresh Floral scent inner layer” and/or other fragrance scented Two Way Air Filter Sheet (+Air Freshener), you can easily turning your Heating and A/C system into an Air Freshener, which will provide your favorite fresh air for your home and office.
d) Special order for Odor treatment. The Two Way Air Filter Sheet can be specialized for customers to solve certain odor problem in their specific area.
